(19) United States
(12) Patent Application Publication
(10) Pub. No.: US 2024/0411606 A1
(43) Pub. Date: Dec. 12, 2024

(54) AUTONOMOUS VEHICLE SYSTEM ON CHIP MAILBOX ARCHITECTURE

(71) Applicant: Mercedes-Benz Group AG, Stuttgart (DE)

(72) Inventor: Francois Piednoel, Sunnyvale, CA (US)

(21) Appl. No.: 18/206,526

(22) Filed: Jun. 6, 2023

(51) Int. Cl. G06F 9/50

(52) U.S. Cl. CPC G06F 9/5038; G06F 9/5016; G06F 9/5072

(57) ABSTRACT

A system-on-chip (SoC) designed for an autonomous vehicle includes a central chiplet to coordinate the operations of the SoC constituent chiplets. The central chiplet includes a shared memory storing a number of programs associated with parallel workload pipelines, one or more processors to execute a scheduling program, and a cache memory accessible by the chiplets of the SoC. The SoC also includes a sensor data input chiplet to receive sensor data from vehicle sensors and store the sensor data in the cache memory. The scheduling program running on the central chiplet schedules the programs and causes respective workloads of the parallel workload pipelines to execute based, at least in part, on the sensor data stored in the cache memory.

### BACKGROUND

Universal Chiplet Interconnect Express (UCIe) provides an open specification for an interconnect and serial bus between chiplets, which enables the production of large system on chip (SoC) packages with intermixed components from different silicon manufacturers. Autonomous vehicle computing systems may operate using chiplet arrangements that follow the UCIe specification. One goal of creating such computing systems is to achieve the robust safety integrity levels of other important electrical and electronic (E/E) automotive components of the vehicle.

### SUMMARY

An on-board, vehicle computing system is described herein that includes a system on chip (SoC) with a number of specialized chiplets to take data from sensors in the vehicle and make decisions for autonomous driving in a functionally safe manner.

As used herein, a system on chip (SoC) is an integrated circuit that combines multiple components of a computer or electronic system onto a single chip, providing a compact and efficient solution for a wide range of applications. The main advantage of an SoC is its compactness and reduced complexity, since all the components are integrated onto a single chip. This reduces the need for additional circuit boards and other components, which can save space, reduce power consumption, and reduce overall cost. The components of an SoC are often referred to as chiplets, which are small, self-contained semiconductor components that can be combined with other chiplets to form the SoC. Chiplets are designed to be highly modular and scalable, allowing for the creation of complex systems from smaller, simpler components and are typically designed to perform specific functions or tasks, such as memory, graphics processing, or input/output (I/O) functions. They are usually interconnected with each other and with a main processor or controller using high-speed interfaces. Chiplets offer increased modularity, scalability, and manufacturing efficiency compared to traditional monolithic chip designs, as well as the ability to be tested individually before being combined into the larger system.

In various implementations, an SoC designed for an autonomous vehicle includes a central chiplet to coordinate the operations of the SoC constituent chiplets. Among other features, the central chiplet includes a shared memory storing a number of programs associated with parallel workload pipelines, one or more processors to execute a scheduling program, and a cache memory accessible by the chiplets of the SoC. The SoC also includes a sensor data input chiplet to receive sensor data from vehicle sensors and store the sensor data in the cache memory. The scheduling program running on the central chiplet schedules the programs and causes respective workloads of the parallel workload pipelines to execute based, at least in part, on the sensor data stored in the cache memory.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system in which embodiments described herein may be implemented, in accordance with examples described herein;

FIG. 2 is a block diagram depicting an example computing system implementing a multiple system-on-chip (SoC), in accordance with examples described herein;

FIG. 3 is a block diagram illustrating an example system on chip, in accordance with examples described herein;

FIG. 4 is a block diagram depicting an example central chiplet of an SoC that includes a shared memory through which the chiplets of the SoC communicate;

FIG. 5 is a timing diagram illustrating operations performed by chiplets of an SoC using a mailbox architecture, according to examples described herein; and

FIG. 6 is a flow chart describing a method of scheduling and executing workloads using a mailbox architecture, according to examples described herein.

### DETAILED DESCRIPTION

In experimentation and controlled testing environments, system redundancies and automotive safety integrity level (ASIL) ratings for autonomy systems are not typically a priority consideration. As autonomous driving features continue to advance (e.g., beyond Level 3 autonomy), and autonomous vehicles begin operating more commonly on public road networks, the qualification and certification of E/E components related to autonomous operation of the vehicle will be advantageous to ensure operational safety of these vehicles. Furthermore, novel methods for qualifying and certifying hardware, software, and/or hardware/software combinations will also be advantageous in increasing public confidence and assurance that autonomous driving systems are safe beyond current standards. For example, certain safety standards for autonomous driving systems include safety thresholds that correspond to average human abilities and care. Yet, these statistics include vehicle incidences involving impaired or distracted drivers and do not factor in specified time windows in which vehicle operations are inherently riskier (e.g., inclement weather conditions, late night driving, winding mountain roads, etc.).

Automotive safety integrity level (ASIL) is a risk classification scheme defined by ISO 26262 (the functional safety for road vehicles standard), and is typically established for the E/E components of the vehicle by performing a risk analysis of potential hazards, which involves determining respective levels of severity (i.e., the severity of injuries the hazard can be expected to cause; classified between S0 (no injuries) and S3 (life-threatening injuries)), exposure (i.e., the relative expected frequency of the operational conditions in which the injury can occur; classified between E0 (incredibly unlikely) and E4 (high probability of injury under most operating conditions)), and controllability (i.e., the relative likelihood that the driver can act to prevent the injury; classified between C0 (controllable in general) and C3 difficult to control or uncontrollable)) of the vehicle operating scenario. As such, the safety goal(s) for any potential hazard event includes a set of ASIL requirements.

Hazards that are identified as quality management (QM) do not dictate any safety requirements. As an illustration, these QM hazards may be any combination of low probability of exposure to the hazard, low level of severity of potential injuries resulting from the hazard, and a high level of controllability by the driver in avoiding the hazard and/or preventing injuries. Other hazard events are classified as ASIL-A, ASIL-B, ASIL-C, or ASIL-D depending on the various levels of severity, exposure, and controllability corresponding to the potential hazard. ASIL-D events correspond to the highest integrity requirements (ASIL requirements) on the safety system or E/E components of the safety system, and ASIL-A comprises the lowest integrity requirements. As an example, the airbags, anti-lock brakes, and power steering system of a vehicle will typically have an ASIL-D grade, where the risks associated with the failure of these components (e.g., the probable severity of injury and lack of vehicle controllability to prevent those injuries) are relatively high.

As provided herein, the ASIL may refer to both risk and risk-dependent requirements, where the various combinations of severity, exposure, and controllability are quantified to form an expression of risk (e.g., an airbag system of a vehicle may have a relatively low exposure classification, but high values for severity and controllability). As provided above, the quantities for severity, exposure, and controllability for a given hazard are traditionally determined using values for severity (e.g., S0 through S3), exposure (e.g., E0 through E4), and controllability (e.g., C0 through C3) in the ISO 26262 series, where these values are then utilized to classify the ASIL requirements for the components of a particular safety system. As provided herein, certain safety systems can perform variable mitigation measures, which can range from alerts (e.g., visual, auditory, or haptic alerts), minor interventions (e.g., brake assist or steer assist), major interventions and/or avoidance maneuvering (e.g., taking over control of one or more control mechanisms, such as the steering, acceleration, or braking systems), and full autonomous control of the vehicle.

Current fully autonomous driving systems can comprise non-deterministic inference models, in which the system executes one or more perception, object detection, object classification, motion prediction, motion planning, and vehicle control techniques based on, for example, two-dimensional image data, to perform all autonomous driving tasks. It is contemplated that such implementations may be difficult or impossible to certify and provide an ASIL rating for the overall autonomous driving system. To address these shortcomings in current implementations, an autonomous driving system is provided herein that may perform deterministic, reflexive inference operations on specified hardware arrangements that allow for the certification and ASIL grading of various components, software aspects of the system, and/or the entire autonomous driving system itself.

In accordance with examples described herein, the use of a dual SoC arrangement in which each SoC in the pair alternates between primary and backup responsibilities can facilitate in the overall certification and ASIL grade of the autonomous driving system of the vehicle. In this arrangement, the first SoC and second SoC utilize isolated power sources and can be electrically coupled to each other by way of eFuses (e.g., active circuit protection devices with integrated field-effect transistors (FETs) used to limit currents and voltages to safe levels during fault conditions), which can further bolster the ASIL grade of the arrangement. The SoCs may have direct memory access to each other (e.g., via a functional safety component of each SoC), which can facilitate dynamic health monitoring, error checks, and seamless transitions between primary and backup status.

In certain implementations, the computing system can perform one or more functions described herein using a learning-based approach, such as by executing an artificial neural network (e.g., a recurrent neural network, convolutional neural network, etc.) or one or more machine-learning models. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

As further provided herein, an “autonomy map” or “autonomous driving map” comprises a ground truth map recorded by a mapping vehicle using various sensors (e.g., LIDAR sensors and/or a suite of cameras or other imaging devices) and labeled to indicate traffic and/or right-of-way rules at any given location. For example, a given autonomy map can be human labeled based on observed traffic signage, traffic signals, and lane markings in the ground truth map. In further examples, reference points or other points of interest may be further labeled on the autonomy map for additional assistance to the autonomous vehicle. Autonomous vehicles or self-driving vehicles may then utilize the labeled autonomy maps to perform localization, pose, change detection, and various other operations required for autonomous driving on public roads. For example, an autonomous vehicle can reference an autonomy map for determining the traffic rules (e.g., speed limit) at the vehicle's current location, and can dynamically compare live sensor data from an on-board sensor suite with a corresponding autonomy map to safely navigate along a current route.

Among other benefits, the examples described herein achieve a technical effect of providing redundancy and functional safety monitoring for SoCs to, for example, increase the safety integrity level of an autonomous vehicle computing system.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable media include permanent memory storage devices, such as hard drives on personal computers or servers. Other examples of computer storage media include portable storage units, such as flash memory or magnetic memory. Computers, terminals, network-enabled devices are all examples of machines and devices that utilize processors, memory, and instructions stored on computer-readable media. Additionally, examples may be implemented in the form of computer programs.

### Example Computing System

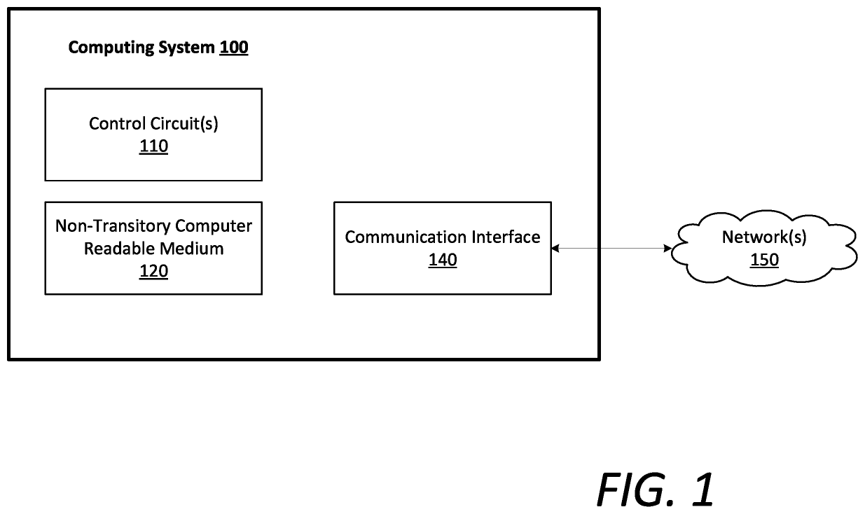

FIG. 1 is a block diagram depicting an example computing system 100 in which embodiments described herein may be implemented, in accordance with examples described herein. In an embodiment, the computing system 100 can include one or more control circuits 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), systems on chip (SoCs), or any other control circuit. In some implementations, the control circuit(s) 110 and/or computing system 100 may be part of, or may form, a vehicle control unit (also referred to as a vehicle controller) that is embedded or otherwise disposed in a vehicle (e.g., a Mercedes-Benz® car, truck, or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, an autonomous vehicle control system, or any other controller (the term “or” is used herein interchangeably with “and/or”).

In an embodiment, the control circuit(s) 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, for example, a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when the control circuit(s) 110 or other hardware components execute the modules or computer-readable instructions.

In further embodiments, the computing system 100 can include a communication interface 140 that enables communications over one or more networks 150 to transmit and receive data. In various examples, the computing system 100 can communicate, over the one or more networks 150, with fleet vehicles using the communication interface 140 to receive sensor data and implement the intersection classification methods described throughout the present disclosure. In certain embodiments, the communication interface 140 may be used to communicate with one or more other systems. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

As an example embodiment, the control circuit(s) 110 of the computing system 100 can include a dual SoC arrangement that facilitates the various methods and techniques described throughout the present disclosure. In various examples, the SoCs can perform a set of tasks in a primary SoC and backup SoC arrangement, where the primary SoC performs the set of tasks, and the backup SoC maintains a standby state and monitors the status and/or state of the primary SoC. In various implementations, the set of tasks can comprise a set of autonomous driving tasks, such as perception, object detection and classification, grid occupancy determination, sensor data fusion and processing, motion prediction (e.g., of dynamic external entities), motion planning, and vehicle control tasks for autonomously operating a vehicle along a travel route. As described herein, multiple dual SoC arrangements may be implemented for performing these tasks, with each SoC pair being configured in the manner described in detail below.

### System Description

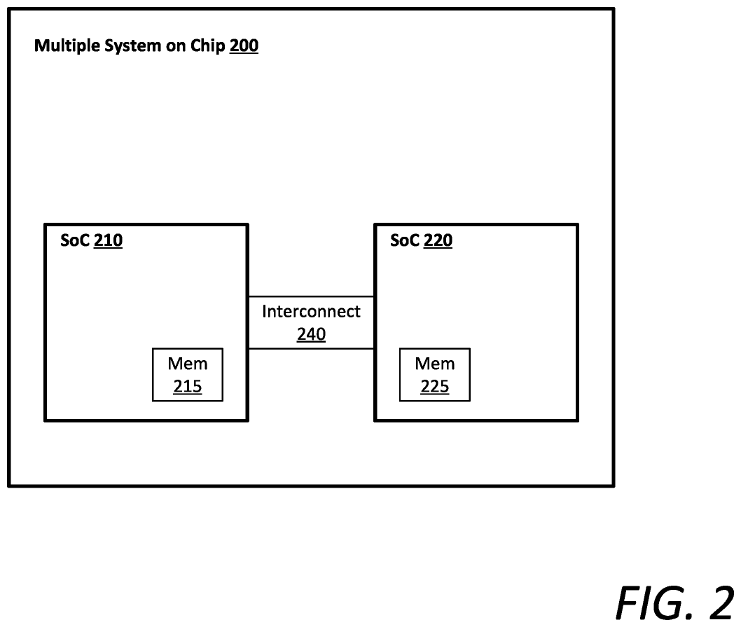

FIG. 2 is a block diagram depicting an example multiple system on chip (MSoC), in accordance with examples described herein. In various examples, the MSoC 200 can include a first SoC 210 having a first memory 215 and a second SoC 220 having a second memory 225 coupled by an interconnect 240 (e.g., an ASIL-D rated chip-to-chip interconnect) that enables each of the first SoC 210 and second SoC 220 to read each other's memories 215, 225. During any given session, the first SoC 210 and the second SoC 220 may alternate roles, between a primary SoC and a backup SoC. As provided herein, the primary SoC can perform various autonomous driving tasks, such as perception, object detection and classification, grid occupancy determination, sensor data fusion and processing, motion prediction (e.g., of dynamic external entities), motion planning, and vehicle control tasks. The backup SoC can maintain a set of computational components (e.g., CPUs, ML accelerators, and/or memory chiplets) in a low power state, and continuously or periodically read the memory of the primary SoC.

For example, if the first SoC 210 is the primary SoC and the second SoC 220 is the backup SoC, then the first SoC 210 performs a set of autonomous driving tasks and publishes state information corresponding to these tasks in the first memory 215. The second SoC 220 reads the published state information in the first memory 215 to continuously check that the first SoC 210 is operating within nominal thresholds (e.g., temperature thresholds, voltage thresholds, bandwidth and/or memory thresholds, etc.), and that the first SoC 210 is performing the set of autonomous driving tasks free from error. In some examples, the nominal thresholds may be taken from manufacturers' specifications or determined through testing processes of the underlying hardware. As such, the second SoC 220 performs health monitoring (i.e., comparing recent values from the first SoC 210 to the nominal thresholds) and error management tasks for the first SoC 210 and takes over control of the set of autonomous driving tasks when a triggering condition is met. As provided herein, the triggering condition can correspond to a fault, failure, or other error experienced, such as exceeding one of the nominal thresholds, by the first SoC 210 that may affect the performance of the set of tasks by the first SoC 210.

In various implementations, the second SoC 220 can publish state information corresponding to its computational components being maintained in a standby state (e.g., a low power state in which the second SoC 220 maintains readiness to take over the set of tasks from the first SoC 210). In such examples, the first SoC 210 can monitor the state information of the second SoC 220 by continuously or periodically reading the memory 225 of the second SoC 220 to also perform health check monitoring and error management on the second SoC 220. For example, if the first SoC 210 detects a fault, failure, or other error in the second SoC 220, the first SoC 210 can trigger the second SoC 220 to perform a system reset or reboot.

In certain examples, the first SoC 210 and the second SoC 220 can each include a functional safety (FuSa) component that performs the health monitoring and error management tasks. The FuSa component can be maintained in a powered state for each SoC, whether the SoC operates in a primary or backup manner. As such, the backup SoC may maintain its other components in a low powered state, with its FuSa component being powered up and performing the heath monitoring and error management tasks described herein.

In various aspects, when the first SoC 210 operates as the primary SoC, the state information published in the first memory 215 can correspond to the set of tasks being performed by the first SoC 210. For example, the first SoC 210 can publish any information corresponding to the surrounding environment of the vehicle (e.g., any external entities identified by the first SoC 210, their locations, and predicted trajectories, detected objects, such as traffic signals, signage, lane markings, and crosswalk, and the like). The state information can further include the operating temperatures of the computational components of the first SoC 210, bandwidth usage and available memory of the chiplets of the first SoC 210, and/or any faults or errors, or information indicating faults or errors in these components.

In further aspects, when the second SoC 220 operates as the backup SoC, the state information published in the second memory 225 can correspond to the state of each computational component of the second SoC 220. In particular, these components may operate in a low power state in which the components are ready to take over the set of tasks being performed by the first SoC 210. The state information can include whether the components are operating within nominal temperatures and other nominal ranges (e.g., available bandwidth, power, memory, etc.).

As described throughout the present disclosure, the first SoC 210 and the second SoC 220 can switch between operating as the primary SoC and the backup SoC (e.g., each time the system 200 is rebooted). For example, in a computing session subsequent to a session in which the first SoC 210 operated as the primary SoC and the second SoC 220 operated as the backup SoC, the second SoC 220 can assume the role of the primary SoC and the first SoC 210 can assume the role of the backup SoC. It is contemplated that this process of switching roles between the two SoCs can provide substantially even wear of the hardware components of each SoC, which can prolong the lifespan of the computing system 200 as a whole.

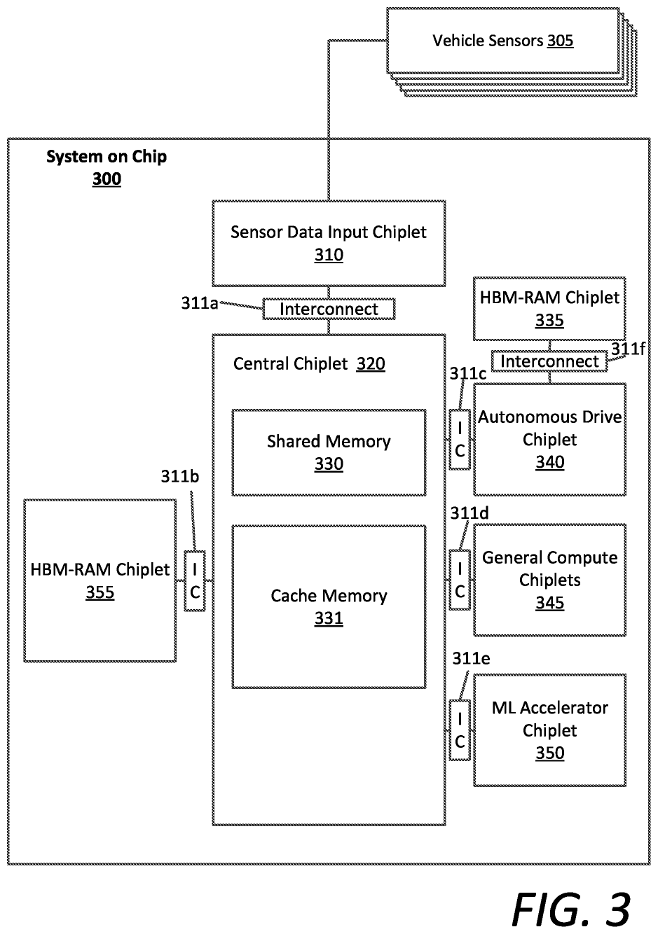

It is contemplated that the MSoC arrangement of the computing system 200 can be provided to increase the safety integrity level (e.g., ASIL rating) of the computing system 200 and the overall autonomous driving system of the vehicle. As described herein, the autonomous driving system can include any number of dual SoC arrangements, each of which can perform a set of autonomous driving tasks. In doing so, the backup SoC dynamically monitors the health of the primary SoC in accordance with a set of functional safety operations, such that when a fault, failure, or other error is detected, the backup SoC can readily power up its components and take over the set of tasks from the primary SoC. Further description of the SoCs and their computational components is provided below with respect to FIG. 3.

### Example SoC

FIG. 3 is a block diagram illustrating an example system on chip 300, in accordance with examples described herein. The system on chip 300 can comprise either the first SoC 210 or the second SoC 220 as shown and described in connection with FIG. 2. Furthermore, the example system on chip 300 shown in FIG. 3 can include additional components, and the components of system on chip 300 may be arranged in various alternative configurations other than the example shown. Thus, the system on chip 300 of FIG. 3 is described herein as an example arrangement for illustrative purposes and is not intended to limit the scope of the present disclosure in any manner.

Referring to FIG. 3, a sensor data input chiplet 310 of the system on chip 300 can receive sensor data from various vehicle sensors 305 of the vehicle. These vehicle sensors 305 can include any combination of image sensors (e.g., single cameras, binocular cameras, fisheye lens cameras, etc.), LIDAR sensors, radar sensors, ultrasonic sensors, proximity sensors, and the like. The sensor data input chiplet 310 can automatically dump the received sensor data as it's received into a cache memory 331 of the central chiplet 320. The sensor data input chiplet 310 can also include an image signal processor (ISP) responsible for capturing, processing, and enhancing images taken from the various vehicle sensors 305. The ISP takes the raw image data and performs a series of complex image processing operations, such as color, contrast, and brightness correction, noise reduction, and image enhancement, to create a higher-quality image that is ready for further processing or analysis by the other chiplets of the SoC 300. The ISP may also include features such as auto-focus, image stabilization, and advanced scene recognition to further enhance the quality of the captured images. The ISP can then store the higher-quality images in the cache memory 331.

In some aspects, the sensor data input chiplet 310 publishes identifying information for each item of sensor data (e.g., images, point cloud maps, etc.) to a shared memory 330 of a central chiplet 320, which acts as a central mailbox for synchronizing workloads for the various chiplets. The identifying information can include details such as an address in the cache memory 331 where the data is stored, the type of sensor data, which sensor captured the data, and a timestamp of when the data was captured.

To communicate with the central chiplet 320, the sensor data input chiplet 310 transmits data through an interconnect 311a. Interconnects 311a-f each represent die-to-die (D2D) interfaces between the chiplets of the SoC 300. In some aspects, the interconnects include a high-bandwidth data path used for general data purposes to the cache memory 331 and a high-reliability data path to transmit functional safety and scheduler information to the shared memory 330. Network on chip (NoC) network interface units (NIU) on the chiplets can be configured to generate error-correcting code (ECC) data on both the high-bandwidth and high-reliability data paths. Each corresponding NIU on its pairing die has the same ECC configuration, which generates and checks the ECC data to ensure end to end error correction coverage. For the high-reliability data paths, the NIUs can transmit the functional safety and scheduler information in two redundant transactions, with the second transaction ordering the bits in reverse (e.g., from bit 31 to 0 on a 32-bit bus) of the order of the first transaction. Furthermore, if errors are detected in the data transfers between chiplets on the high-reliability data path, the NIUs can reduce the transmission rate to improve reliability.

Depending on bandwidth requirements, an interconnect may include more than one die-to-die interface. For example, interconnect 311a can include two interfaces to support higher bandwidth communications between the sensor data input chiplet 310 and the central chiplet 320.

In one aspect, the interconnects 311a-f implement the Universal Chiplet Interconnect Express (UCIe) standard and communicate through an indirect mode to allow each of the chiplet host processors to access remote memory as if it were local memory. This is achieved by using specialized NoC NIUs that provide hardware-level support for remote direct memory access (RDMA) operations. These NIUs also allow for freedom from interference between devices connected to the network. In UCIe indirect mode, the host processor sends requests to the NIU, which then accesses the remote memory and returns the data to the host processor. This approach allows for efficient and low-latency access to remote memory, which can be particularly useful in distributed computing and data-intensive applications. Additionally, UCIe indirect mode provides a high degree of flexibility, as it can be used with a wide range of different network topologies and protocols.

In various examples, the system on chip 300 can include additional chiplets that can store, alter, or otherwise process the sensor data cached by the sensor data input chiplet 310. The system on chip 300 can include an autonomous drive chiplet 340 that can perform operations to determine the physical characteristics of the environment around the sensors. These operations can include perception, sensor fusion, trajectory prediction, and/or other autonomous driving algorithms of an autonomous vehicle. To perform these operations, the autonomous drive chiplet 340 can include specialized hardware such as digital signal processors (DSP), a direct memory access (DMA) engine, and neural network (NN) accelerators. The autonomous drive chiplet 340 can be connected to a dedicated HBM-RAM chiplet 335 in which the autonomous drive chiplet 340 can publish all status information, variables, statistical information, and/or processed sensor data as processed by the autonomous drive chiplet 340.

In various examples, the system on chip 300 can further include a machine-learning (ML) accelerator chiplet 340 that is specialized for accelerating Artificial Intelligence (AI) workloads, such as image inferences or other sensor inferences using machine learning, in order to achieve high performance and low power consumption for these workloads. The ML accelerator chiplet 340 can include an engine designed to efficiently process graph-based data structures, which are commonly used in AI workloads, and a highly parallel processor, allowing for efficient processing of large volumes of data. The ML accelerator chiplet 340 can also include specialized hardware accelerators for common AI operations such as matrix multiplication and convolution as well as a memory hierarchy designed to optimize memory access for AI workloads, which often have complex memory access patterns.

The general compute chiplets 345 can provide general purpose computing for the system on chip 300. For example, the general compute chiplets 345 can comprise high-powered central processing units and/or graphical processing units that can support the computing tasks of the central chiplet 320, autonomous drive chiplet 340, and/or the ML accelerator chiplet 350.

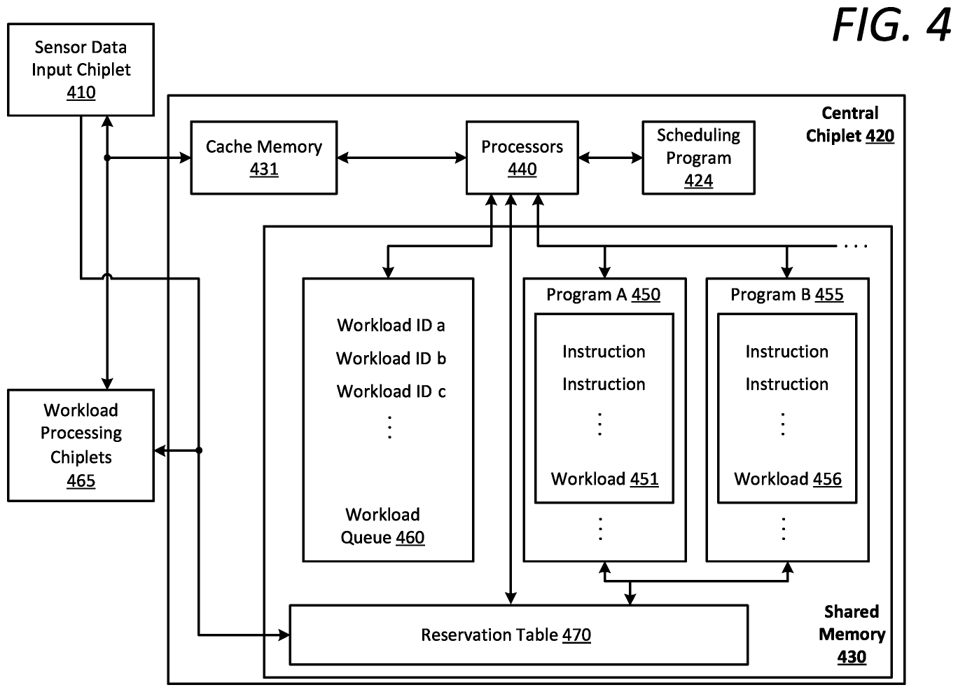

In various implementations, the shared memory 330 can store programs and instructions for performing autonomous driving tasks. The shared memory 330 of the central chiplet 320 can further include a reservation table that provides the various chiplets with the information needed (e.g., sensor data items and their locations in memory) for performing their individual tasks. Further description of the shared memory 330 in the context of the dual SoC arrangements described herein is provided below with respect to FIG. 4. The central chiplet 320 also includes the large cache memory 331, which supports invalidate and flush operations for stored data.

Cache miss and evictions from the cache memory 331 are sent by a high-bandwidth memory (HBM) RAM chiplet 355 connected to the central chiplet 320. The HBM-RAM chiplet 355 can include status information, variables, statistical information, and/or sensor data for all other chiplets. In certain examples, the information stored in the HBM-RAM chiplet 355 can be stored for a predetermined period of time (e.g., ten seconds) before deleting or otherwise flushing the data. For example, when a fault occurs on the autonomous vehicle, the information stored in the HBM-RAM chiplet 355 can include all information necessary to diagnose and resolve the fault. Cache memory 331 keeps fresh data available with low latency and less power required compared to accessing data from the HBM-RAM chiplet 355.

FIG. 4 is a block diagram depicting an example central chiplet of an SoC that includes a shared memory through which the chiplets of the SoC communicate. The central chiplet 420 shown in FIG. 4 can correspond to the central chiplet 320 of the system on chip 300 as shown and described with respect to FIG. 3. Furthermore, the workload processing chiplets 465 shown in FIG. 4 can correspond to the autonomous drive chiplet 340, general compute chiplets 345, and/or ML accelerator chiplet 350 of FIG. 3.

Referring to FIG. 4, the central chiplet 420 includes a shared memory 430 that stores state information published by the processors 440 of the central chiplet 420 as well as the other chiplets of the SoC, including the sensor data input chiplet 410 and a plurality of workload processing chiplets 465.

The workload processing chiplets 465 execute workloads in a number of workload pipelines organized into programs such that successive workloads of the pipeline are dependent on the outputs of preceding workloads in the pipeline. In various implementations, the workload processing chiplets 465 can execute instructions belonging to workloads 451, 456 of multiple workload pipelines in parallel, with each workload pipeline including a plurality of workloads 451, 456 to be executed in a deterministic manner. Each workload pipeline can provide sequential outputs (e.g., for other workload pipelines or for processing by one of the autonomous drive programs for autonomously operating the vehicle).

In some aspects, the processors 440 fetch workloads such as workloads 451, 456 from their respective programs and place their corresponding workload identifiers in a workload queue 460. The scheduling program 424 can read from the workload queue 460 to create entries in the reservation table 470, the entries including the workload identifiers, status, and dependencies, among other data.

As illustrated, program A 450 includes workload 451, among others not shown, and program B 455 includes workload 456, among others not shown. In some examples, program A 450 represents a reflex program, and program B 455 represents an application program. As provided herein, the reflex program can comprise a set of instructions for executing reflex workloads in independent pipelines. The reflex workloads can comprise sensor data acquisition, sensor fusion, and inference tasks that facilitate scene understanding of the surrounding environment of the vehicle. These tasks can comprise two-dimensional image processing, sensor fused data processing (e.g., three-dimensional LIDAR, radar, and image fusion data), neural radiance field (NeRF) scene reconstruction, occupancy grid determination, object detection and classification, motion prediction, and other scene understanding tasks for autonomous vehicle operation.

The application program can comprise a set of instructions for operating the vehicle controls of the autonomous vehicle based on the output of the reflex workload pipelines. For example, the application program can be executed by one or more processors 440 of the central chiplet 420 and/or one or more of the workload processing chiplets 465 (e.g., the autonomous drive chiplet 340 of FIG. 3) to dynamically generate a motion plan for the vehicle based on the execution of the reflex workloads, and operate the vehicle's controls (e.g., acceleration, braking, steering, and signaling systems) to execute the motion plan accordingly.

In certain examples, one or more of the processors 440 can execute reflex workloads in accordance with the reflex program and/or application workloads in accordance with the application program. As such, the processors 440 of the central chiplet 420 can reference, monitor, and update dependency information in workload entries of the reservation table 470 as workloads become available and are executed. For example, when a workload is executed by a particular chiplet, the chiplet updates the dependency information of other workloads in the reservation table 470 to indicate that the workload has been completed. This can include changing a bitwise operator or binary value representing the workload (e.g., from 0 to 1) to indicate in the reservation table 470 that the workload has been completed. Accordingly, the dependency information for all workloads having dependency on the completed workload is updated accordingly.

In some aspects, the processors include a transient-resistant CPU core to run the scheduling program 424. The transient-resistant CPU core is designed to resist and recover from transient faults caused by environmental factors such as cosmic radiation, power surges, and electromagnetic interference. These faults can cause the CPU to malfunction or produce incorrect results, potentially leading to system failures or security vulnerabilities. To address these issues, the transient-resistant CPU core can include a range of hardware-based fault detection and recovery mechanisms, such as redundant execution units, error-correcting code (ECC) memory, and register duplication. These mechanisms can detect and correct errors in real-time, ensuring that the CPU continues to function correctly even in the presence of transient faults. Additionally, the transient-resistant CPU core may include various software-based fault tolerance techniques, such as checkpointing and rollback, to further enhance system reliability and resilience.

In some aspects, the workload processing chiplets 465 monitor the reservation table 470 to determine whether particular workloads in their respective pipelines are ready for execution. The reservation table 470 can include workload entries, each of which indicates a workload identifier that describes the workload to be performed, an address in the cache memory 431 and/or HBM-RAM of the location of raw or processed sensor data required for executing the workload, and any dependency information corresponding to dependencies that need to be resolved prior to executing the workload. In certain aspects, the dependencies can correspond to other workloads that need to be executed. Once the dependencies for a particular workload are resolved, the workload entry can be updated (e.g., by the chiplet executing the dependent workloads, or by the processors 440 of the central chiplet 420 through execution of the scheduling program 424). When no dependencies exist for a particular workload as referenced in the reservation table 470, the workload can be executed in a respective pipeline by a corresponding workload processing chiplet 465.

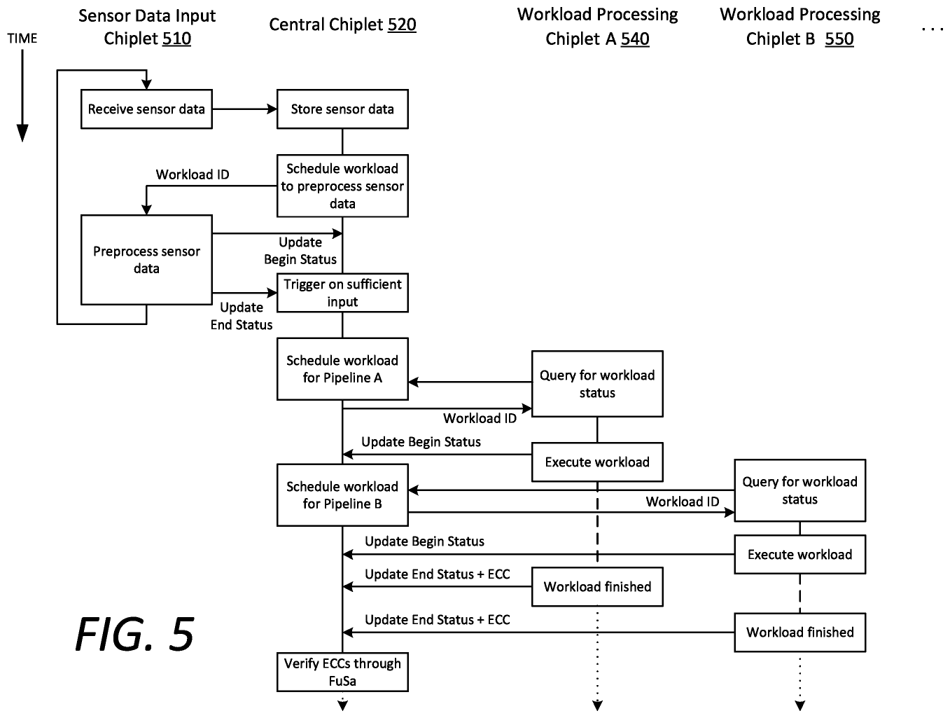

FIG. 5 is a timing diagram illustrating operations performed by chiplets of an SoC using a mailbox architecture. FIG. 5 illustrates operations performed by a sensor data input chiplet 510, which may correspond to the sensor data input chiplet 310 of FIG. 3, and a central chiplet 520, which may correspond to the central chiplet 320 of FIG. 3. As illustrated, operations are performed from top to bottom, although some operations may occur in orders other than the example illustrated.

In some aspects, the sensor data input chiplet 510 receives sensor data from one of the vehicle sensors. The sensor data input chiplet 510 transmits the sensor data across the D2D interface to store the data in the cache memory on the central chiplet 520.

Upon receiving an indication that new data is stored in the cache memory, the central chiplet 520 can create a new workload identifier and schedule a workload for the sensor data input chiplet 510 to pre-process the sensor data.

In one aspect, the workload identifier is a 64-bit number that uniquely identifies a specific workload within the system. The workload identifier can encode multiple pieces of useful information, including a memory address, within the uniform memory address space shared among the chiplets of the SoC, where the data associated with the workload is currently stored. The workload identifier can also encode type and source information for the associated data, such as whether the data is a camera image, a LIDAR image, etc. and which specific sensor captured the original data. The workload identifier can also include a timestamp of when the workload and/or data were created so that the chiplets of the SoC can determine an age of the workload and/or data. Furthermore, the workload identifier can include an ASIL rating and a priority level indicator for the workload.

In some aspects, the sensor data input chiplet 510 uses an image signal processor (ISP) to pre-process the sensor data. The ISP takes the raw image data and performs a series of complex image processing operations, such as color, contrast, and brightness correction, noise reduction, and image enhancement, to create a higher-quality image that is ready for further processing or analysis by the other chiplets of the SoC. The ISP may also include features such as auto-focus, image stabilization, and advanced scene recognition to further enhance the quality of the captured images. The ISP can then store the higher-quality images in the cache memory.

Once the central chiplet 520 has a preprogrammed sufficient amount of sensor data in the cache memory, the scheduling program on the central chiplet 520 can create a workload for one of a plurality of parallel workload pipelines to process the sensor data together. For example, if the preprogrammed sufficient amount of camera data to perform pedestrian detection is eight images, then the scheduling program can create a workload for the ML accelerator chiplet to perform pedestrian detection once eight images are available in the cache memory.

In some aspects, a workload processing chiplet A 540 periodically queries a reservation table on the central chiplet 520 to determine the next workload that needs to be processed in one of the pipelines. The workload processing chiplet A 540 specifically queries the reservation table to find the first workload that matches a type of workload that workload processing chiplet A 540 is designed to process and which has no unresolved dependencies pending. If such a workload is found, the central chiplet 520 responds with the workload identifier of the workload.

The workload processing chiplet A 540 sends a timestamped notification (e.g., a date or partial date timestamp in milliseconds) to the reservation table on the central chiplet 520 indicating a begin status for the workload to be processed. The workload processing chiplet A 540 begins executing the instructions of the workload to process the data at the memory location indicated by the workload identifier. For example, the workload processing chiplet A 540 may begin execution at timestamp 1. In one aspect, the begin status indication and the corresponding end status notification are ASIL certified and sent over the high-reliability data path.

Meanwhile, the central chiplet 520 continues scheduling workloads for the parallel pipelines to be executed by workload processing chiplet A 540, workload processing chiplet B 550, or further chiplets not illustrated. For example, as illustrated, the central chiplet 520 may schedule a workload for pipeline B, and workload processing chiplet B 550 may begin executing the instructions of the workload at timestamp 2 while workload processing chiplet A 540 continues processing the first workload for pipeline A. In some examples, each chiplet may execute appropriate workloads for any of the pipelines as the workloads come available.

Upon completing the workload, workload processing chiplet A 540 updates the reservation table to indicate that the workload is finished and unlocks the workload. For example, workload processing chiplet A 540 may finish the workload at timestamp 3 and update the reservation table, regardless of the progress of workload processing chiplet B 550. Once unlocked, the resulting processed data from the workload are available to be used by additional workloads that were depending on the locked workload. The workload processing chiplet A 540 also stores the processed data in the cache memory on the central chiplet 520. Workload processing chiplet B 550 may finish the workload for pipeline B at timestamp 4 and update the reservation table accordingly.

In one aspect, the workload processing chiplet A 540 and the central chiplet 520 perform an error correction check to verify that the processed data was sent and stored in the cache memory completely and without corruption. For example, the workload processing chiplet A 540 generates an error correction code (ECC) using the processed data and transmits the ECC to the central chiplet 520. While the data itself is transmitted along a high-bandwidth path between chiplets, the ECC is sent along a high-reliability path. Upon receiving the data, the central chiplet 520 generates its own ECC using the data. A functional safety call in the central chiplet 520 mailbox can then compare the two ECCs to ensure that they match, which verifies that the data was transmitted correctly.

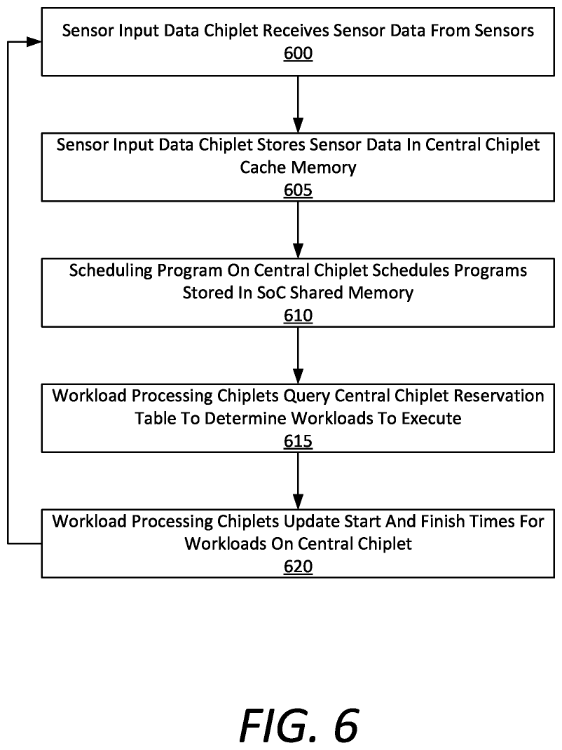

FIG. 6 is a flow chart describing a method of scheduling and executing workloads using a mailbox architecture. In one example, a sensor data input chiplet of a plurality of chiplets of a system-on-chip architecture receives sensor data from sensors (e.g., cameras, radar, LIDAR, etc. on an autonomous vehicle) (600). The sensor data input chiplet stores the received sensor data in a cache memory on the central chiplet that is accessible by the plurality of chiplets (605).

In some aspects, a scheduling program on the central chiplet schedules a plurality of programs stored in a shared memory of the central chiplet (610). These stored programs are associated with a plurality of parallel workload pipelines, and, as a result of the scheduling, respective workloads of the plurality of parallel workload pipelines are executed based on data, such as the sensor data, stored in the cache memory. In one example, the sensor data input chiplet can execute a workload to pre-process the sensor data. In another example, a machine-learning accelerator chiplet calculates inferences using camera data that has been pre-processed and stored in the cache memory.

In some aspects, each workload processing chiplet in the SoC queries a reservation table on the central chiplet shared memory to determine which workload to execute next (615). Each workload processing chiplet determines whether a given workload in the table is of a type it is designed to execute, and if so, whether a set of dependency conditions is satisfied before beginning execution of the workload.

Once a workload has been chosen from the reservation table, the workload processing chiplet can update the reservation table with a starting time for that workload (620). In addition, the workload processing chiplet can update the reservation table with a finishing time for the workload once processing of that workload is completed. Processed data created as a result of the workload execution can be stored in the cache memory on the central chiplet, and additional workloads in the plurality of parallel workload pipelines execute based on the processed data. For example, completion of the workload and/or storing the processed data in the cache memory may clear a dependency in the reservation table that was preventing one of the additional workloads from being executed, and therefore the additional workload may execute due to the dependency being cleared.

It is contemplated for examples described herein to extend to individual elements and concepts described herein, independently of other concepts, ideas, or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. A computing system comprising a plurality of chiplets, the plurality of chiplets including:
a central chiplet including:
(a) a shared memory storing a plurality of programs associated with a plurality of parallel workload pipelines,
(b) one or more processors to execute a scheduling program, and
(c) a cache memory accessible by the plurality of chiplets; and
a sensor data input chiplet to receive sensor data from a plurality of sensors and store the sensor data in the cache memory;
wherein the scheduling program schedules the plurality of programs and causes respective workloads of the plurality of parallel workload pipelines to execute based, at least in part, on the sensor data stored in the cache memory.

2. The computing system of claim 1, wherein the respective workloads are each referenced by a workload identifier that includes an address within a uniform memory address space where data associated with each workload is stored.

3. The computing system of claim 1, wherein the plurality of chiplets includes a plurality of workload processing chiplets, and instructions corresponding to the respective workloads are executed on either the sensor data input chiplet or one of the plurality of workload processing chiplets.

4. The computing system of claim 3, wherein one of the respective workloads executed on the sensor data input chiplet includes pre-processing the sensor data.

5. The computing system of claim 3, wherein the plurality of workload processing chiplets store processed data in the cache memory, and additional workloads in the plurality of parallel workload pipelines execute based on the processed data.

6. The computing system of claim 3, wherein the plurality of workload processing chiplets access entries in a reservation table in the shared memory to determine whether a set of dependency conditions are satisfied to begin execution of the respective workloads.

7. The computing system of claim 6, the plurality of workload processing chiplets update the reservation table with a starting time and a finishing time for executing each workload.

8. The computing system of claim 3, wherein the plurality of workload processing chiplets includes a machine learning accelerator chiplet to calculate inferences using machine learning.

9. The computing system of claim 3, wherein the plurality of workload processing chiplets includes an autonomous drive chiplet to calculate autonomous driving algorithms.

10. A system for a multiple chiplet architecture comprising:
a central chiplet including:
(a) a shared memory storing a plurality of programs associated with a plurality of parallel workload pipelines,
(b) one or more processors to execute a scheduling program, and
(c) a cache memory accessible by a plurality of chiplets; and
a sensor data input chiplet to receive sensor data from a plurality of sensors and store the sensor data in the cache memory;
wherein the scheduling program schedules the plurality of programs and causes respective workloads of the plurality of parallel workload pipelines to execute based, at least in part, on the sensor data stored in the cache memory.

11. The system of claim 10, wherein the respective workloads are each referenced by a workload identifier that includes an address within a uniform memory address space where data associated with each workload is stored.

12. The system of claim 10, wherein the plurality of chiplets includes a plurality of workload processing chiplets, and instructions corresponding to the respective workloads are executed on either the sensor data input chiplet or one of the plurality of workload processing chiplets.

13. The system of claim 12, wherein one of the respective workloads executed on the sensor data input chiplet includes pre-processing the sensor data.

14. The system of claim 12, wherein the plurality of workload processing chiplets store processed data in the cache memory, and additional workloads in the plurality of parallel workload pipelines execute based on the processed data.

15. The system of claim 12, wherein the plurality of workload processing chiplets access entries in a reservation table in the shared memory to determine whether a set of dependency conditions are satisfied to begin execution of the respective workloads.

16. The system of claim 15, the plurality of workload processing chiplets update the reservation table with a starting time and a finishing time for executing each workload.

17. The system of claim 12, wherein the plurality of workload processing chiplets includes a machine learning accelerator chiplet to calculate inferences using machine learning.

18. The system of claim 12, wherein the plurality of workload processing chiplets includes an autonomous drive chiplet to calculate autonomous driving algorithms.

19. A non-transitory computer readable medium storing instructions that, when executed by one or more processors of a computing system, cause the computing system to:
at a sensor input data chiplet of a system-on-chip, receive sensor data from a plurality of sensors and store the sensor data in a cache memory of a central chiplet; and
at the central chiplet, schedule a plurality of programs associated with a plurality of parallel workload pipelines to cause respective workloads to execute based, at least in part, on the sensor data stored in the cache memory.

20. The non-transitory computer readable medium of claim 19, wherein the respective workloads are each referenced by a workload identifier that includes an address within a uniform memory address space where data associated with each workload is stored.
